(19) United States
(12) Patent Application Publication
(10) Pub. No.: US 2008/0218593 A1
(43) Pub. Date: Sep. 11, 2008

(54) MULTI-STREAMING WEB CAMERA CONTROLLING SYSTEM AND CONTROLLING METHODOLOGY OF THE SAME

(75) Inventors: Chien-hsu Chen, Lujhou City (TW); Wen-ming Huang, Dasi Township (TW); Nei-chiung Perng, Taipei City (TW); Chih-jung Lin, Taoyuan City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/970,264

(22) Filed: Jan. 7, 2008

(30) Foreign Application Priority Data
Mar. 8, 2007 (TW) 096108081

(51) Int. Cl. H04N 5/232

(52) U.S. Cl. 348/207.11

(57) ABSTRACT

A multi-streaming web camera controlling system and controlling methodology are capable of providing an original video data stream and at least one compressed video data stream for displaying demands of local host and for requested video data format(s) by remote hosts, respectively. The host can selectively display the original video data stream and transmit the compressed video data stream(s) through the Internet directly in order to satisfy the video requirements of both the local host and remote hosts. The multi-streaming web camera controlling system and controlling methodology can reduce the consuming system resource of the host for processing a video data stream. Therefore, the multi-streaming web camera controlling system and controlling methodology are capable of decreasing the cost of the host and improving the performance for processing video data stream with improved quality.

### BACKGROUND OF THE INVENTION

1. Field of the Invention

The present invention relates to a multi-streaming web camera controlling system and a controlling methodology of the same, and more particularly, to a camera sensor controlling system capable of delivering original video data stream and generating compressed video data stream at the same time and a controlling methodology of the same.

2. Description of Prior Art

Web cameras (Web Cam), on account of attributing to low cost, easy-to-use, and rapid broadcasting, are widely applied to various devices such as video conference systems, web video telephones, surveillance systems, and instant messaging programs (IM programs).

Please refer to FIG. 1, which shows a functional block diagram of a web camera controlling system according to a first prior art. The web camera controlling system according to the prior art includes an image sensor 102, a web camera controlling chip 104, a peripheral interface port 120, a host device 130, a compression module 140 and the Internet 150. The web camera controlling chip 104 includes a sensor interface 106 and a peripheral transmission interface 108. After perceiving an image, the image sensor 102 outputs an analog sensing image data 182 to the web camera controlling chip 104, wherein the analog sensing image data 182 is converted into a digital image data, which is called original video data stream 184, via the sensor interface 106. Consequently, the original video data stream 184 is transmitted to the peripheral interface port 120 via the peripheral transmission interface 108, and then to the host device 130 via the peripheral interface port 120, such that the host device 130 may directly display the original video data stream 184. When being transmitted via the Internet 150, the original video data stream 184 must, due to the bandwidth limitation of the Internet, be compressed into the data in a smaller format before being transmitted to a remote corresponding system, then be restored to a recognizable image, for economizing the bandwidth of the internet 150 and shortening transmission time. Thus, the host device 130, via the compression module 140 (software or hardware), compresses the original video data stream 184 into the compressed video data stream 186, which is then transmitted to a remote end via the Internet 150. The compression module 140 is configured within the host device 130 and is implemented as software program or hardware equipment. Therefore, a large occupancy of system resource of the host device 130 for compressing the original video data stream 184 weakens the execution efficiency of the host device 130, or probably even delays image transmission and degrades image quality.

Please also refer to FIG. 2, which shows a functional block diagram of the web camera controlling system according to a second prior art. The web camera controlling systems according to the first and second prior art are similar. One difference between the two is that, as can be seen in FIG. 2, a compression module 210 is configured in a web camera controlling chip 204, and a host device 230 has a decompression module 270. The web camera controlling system utilizes the compression module 210 to compress the original video data stream 284 within the web camera controlling chip 204, wherein a compressed video data stream 286 is outputted directly. After being fed the compressed video data stream 286 via the peripheral interface port 220, the host device 230 restores the compressed video data stream 286 to the original video data stream 284 via the decompression module 270, so as to display the original video data stream 284. If the original video data stream 284 is transmitted via the Internet 250, the host device 230 may directly transmit the compressed video data stream 286 via the Internet 250 without compressing process.

The prior art of the second prior art has a disadvantage: for the reason that the host device 230 fails to directly utilize the compressed video data stream 286 to display image, the original video data stream 284 can only be displayed on the host device 230, after the decompression module 270 decompressing the compressed video data stream 286. Meanwhile, similar with a problem according to the prior art of the first category, the web camera controlling system according to the prior art of the second category also occupies the system resource of the host device 230 for decompressing the compressed video data stream 286.

Hence, it is necessary to provide an ameliorated web camera controlling system and a controlling methodology of the same, for a host device to promptly display and transmit image data.

### SUMMARY OF THE INVENTION

Accordingly, an objective of the present invention is to provide a multi-streaming web camera controlling system and a controlling methodology of the same, which can deliver original video data stream and generate compressed video data stream at the same time, such that a host device rapidly and selectively displays or transmits image data for the video demand required by the local and the remote hosts, respectively.

The multi-streaming web camera controlling system comprises an image sensor, a web camera controlling chip, a peripheral interface port, a host device, and the Internet. The web camera controlling chip includes a sensor interface, a control unit, a peripheral transmission interface and a plurality of compression modules. After being fed image, the image sensor outputs a sensing image data to the web camera controlling chip, wherein the sensor interface coupling the image sensor converts the analog sensing image data into a digital original video data stream. The sensor interface receives at least a sensing image data and converts the sensing image data into an original video data stream. Each compression module compresses the original video data stream into a compressed video data stream in a corresponding image compression format. The control unit specifies compression modules to compress the original video stream into desirable compressed data streams in corresponding video format, and turns off the other unused compression modules, thereby reducing system resource and power consumption of the web camera controlling chip. The peripheral transmission interface transmits the original video data stream and the compressed video data stream to the host device, via the peripheral interface port. In this way, the host device is capable of displaying the original video data stream without decompressing processing. Moreover, the host device can also transmit the compressed video data stream via the Internet. As a result, the multi-streaming web camera controlling system not only accelerates the speed of image data processing but also reserves system resource of the host device and the Internet bandwidth.

Additionally, the web camera controlling chip could be extended to utilize a plurality of image sensors and to generate various compressed data streams with the multiple sensing image data simultaneously. For the speed of processing the video data stream is faster than that of outputting the sensing image data of each image sensor, the web camera controlling chip is capable of multi-processing the sensing image data without influencing the quality of image data.

According to the claimed invention, the method of controlling a multi-streaming web camera comprises the steps of:

Step 1: The web camera controlling chip utilizes the sensor interface to receive the sensing image data output from the image sensor.
Step 2: The sensor interface converts the received sensing image data into the original video data stream, which is then transmitted to the peripheral transmission interface and the compression modules simultaneously.
Step 3: The compression modules compress the original video data stream into the compressed video data stream in corresponding data format, which are then transmitted to the peripheral transmission interface.
Step 4: The peripheral transmission interface transmits the original video data stream and the compressed video data stream(s) to the host device, via the peripheral interface port.
Step 5: The host device can directly display the original video data stream and selectively transmit the compressed video data stream to remote devices via the Internet.

Compared to the prior art, the multi-streaming web camera controlling system and the controlling methodology of the same according to the present invention, based on the image data format required by host device, generate an original video data stream and one or more corresponding compressed video data stream at the same time. Therefore, the host device may directly display the original video data stream or transmit the compressed video data stream via the Internet, to simultaneously satisfy the need for video required by the local and the remote hosts. Furthermore, without influencing the quality of image data, the occupancy of system resource by the host device for image processing is reduced, thereby lowering the setup cost of host device and accelerating the speed of image data processing.

The present invention will be described with reference to the accompanying drawings, which show various embodiments of the invention and which are incorporated in the specification hereof by reference.

### BRIEF DESCRIPTION OF THE DRAWINGS

FIG. 1 shows a functional block diagram of a web camera controlling system according to a first prior art.

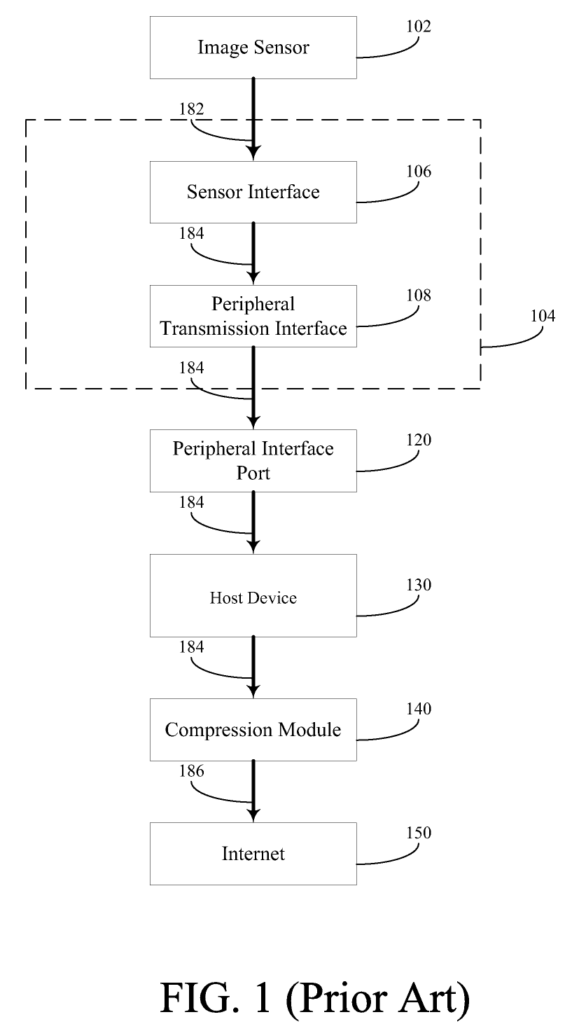

FIG. 2 shows a functional block diagram of the web camera controlling system according to a second prior art.

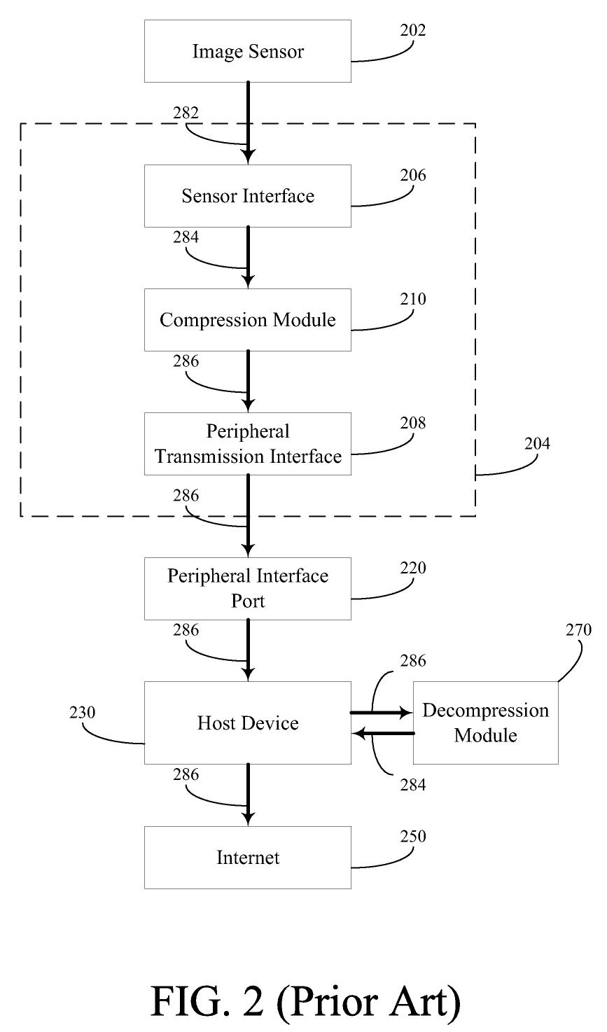

FIG. 3 shows a functional block diagram of the multi-streaming web camera controlling system according to a first embodiment of the present invention.

FIG. 4 shows a functional block diagram of the multi-streaming web camera controlling system according to a second embodiment of the present invention.

FIG. 5 illustrates a flow chart of the multi-streaming web camera controlling system and a controlling methodology of the same according to the present invention.

### DETAILED DESCRIPTION OF THE INVENTION

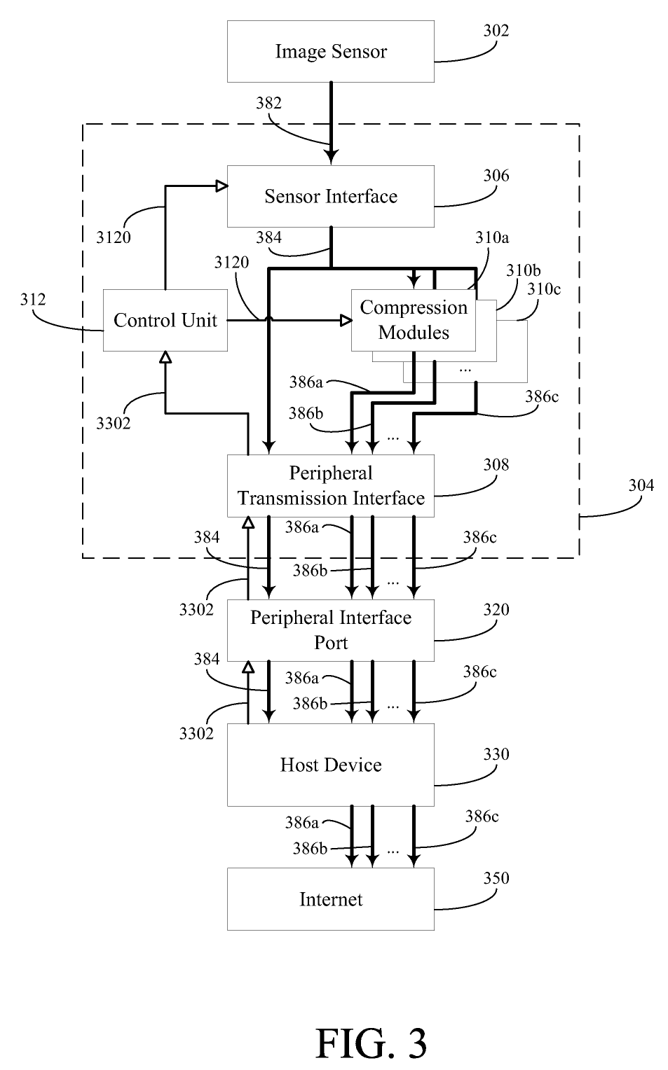

Please refer to FIG. 3, which shows a functional block diagram of the multi-streaming web camera controlling system according to a first embodiment of the present invention. The multi-streaming web camera controlling system includes an image sensor 302, a web camera controlling chip 304, a peripheral interface port 320, a host device 330 and the Internet 350. The web camera controlling chip 304 includes a sensor interface 306, a control unit 312, a peripheral transmission interface 308 and a plurality of compression modules 310a, 310b and 310c. After being fed image, the image sensor 302 outputs a sensing image data 382 to the web camera controlling chip 304, wherein the sensor interface 306 coupling the image sensor 302 converts the analog sensing image data 382 into a digital original video data stream 384.

Then, the control unit 312 compresses the original video data stream 384 into the respective compressed video data stream 386a, 386b and 386c in various image compression formats, via the compression modules 310a, 310b and 310c. The function of the compression modules 310a, 310b and 310c may be adjusted or be set up according to users' requirements, such that the control unit 312 may control the compression modules 310a, 310b and 310c to output the compressed video data stream in various formats at the same time. Controversially, suppose that a user only requires one specific compression image format, the control unit 312 then activates only one corresponding compression module to output the desirable compressed image format, and turns off the other compression modules unused for power saving. Various compression image formats includes the formats well-known in the field or the others such as MPEG1, MPEG2, MPEG4, H.263, H.264/AVC, Real Video, VC-1, AVS, etc., but not to be limited thereto. Thus, the quantity of compression modules according to the present invention and the category of compression image format can be adjusted according to users' real requirements.

Next, the peripheral transmission interface 308 transmits, the original video data stream 384 from the sensor interface 306 and the compressed video data stream 386a, 386b and 386c respectively from the compression modules 310a, 310b and 310c at the same time, to the host device 330 via the peripheral interface port 320. On account of the buffer within the peripheral interface port 320, the host device 330 directly utilizes the original video data stream 384 to constantly display images without any decompression processing. On the other hand, the host device 330 may also directly transmit any one or a plurality of the compression image data 386a, 386b and 386c desirable to a remote demander via the Internet 350. Thus, the host device 330 according to the present invention may, without any additional processing program on the original video data stream 384 or the compressed video data stream 386a, 386b and 386c, directly utilize corresponding image data, so as to economize the system resource of the host device 330 and accelerate the corresponding image processing. On the other hand, on account of no compression or decompression processing on image data, it is not necessary to install any corresponding compression or decompression module in the host device 330, thereby reducing the specification requirement for the host device 330 and the setup cost thereof.

When only one original video data stream 384 or one of the image data 386a, 386b or 386c in specific compression image format is required, the host device 330 sends a controversy instruction 3302 to the control unit 312, via the peripheral interface port 320 and the peripheral delivery interface 308. The control unit 312, based on the instruction 3302, separately generates control signal 3120 to control the compression modules 310a, 310b and 310c, so as to turn off a compression module unused or turn on an appointed one for image processing. On the other hand, the control unit 312 may constantly detect the feedback signal from the host device 330. When the host device 330 fails to respond to a channel for transmitting specific image data format within a supposed time, the control unit 312 turns off the circuit region of corresponding channels, until the host device 330 instructs again a desirable image data format. At a result, the power consumption by the web camera controlling chip 304 is reduced. Furthermore, the control unit 312 may also receive an instruction from the host device 330 to generate a control signal 3120 for the sensor interface 306 to control the pick-up of image.

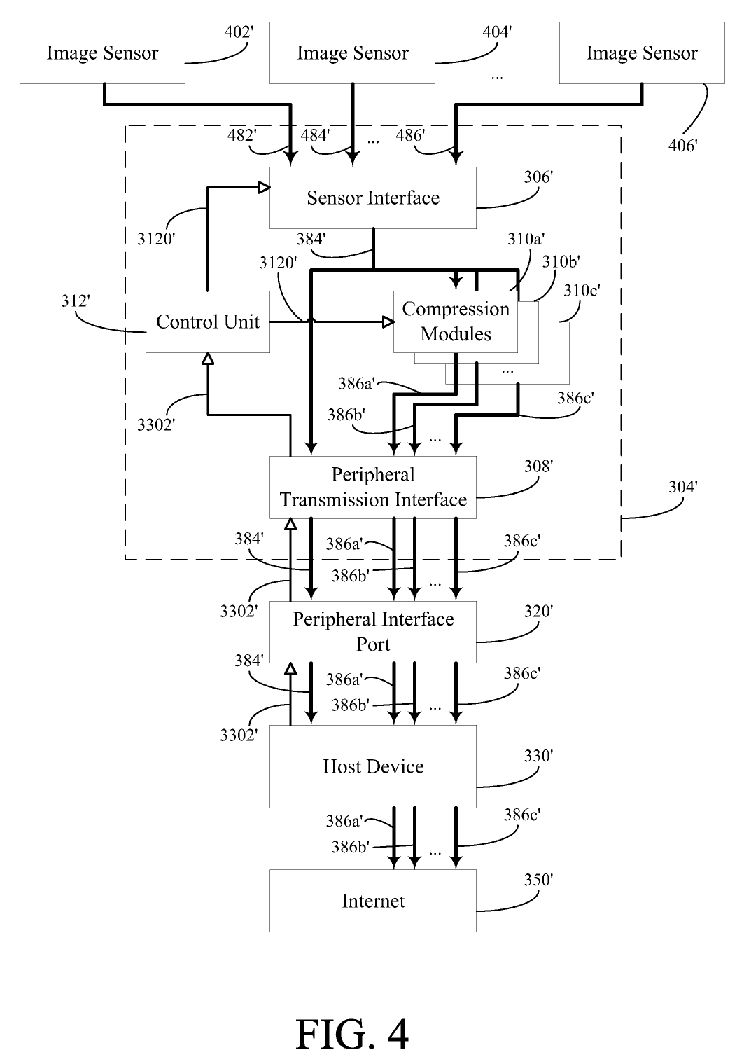

FIG. 4 shows a functional block diagram of the multi-streaming web camera controlling system of a second embodiment according to the present invention. The second embodiment is almost the same as the first one, and a difference between the two is that, the web camera controlling chip 304′ may receive and handle the sensing image data 482′, 484′ and 486′ output from a plurality of image sensors 402′, 404′ and 406′ at the same time. The frame rate of a conventional image sensor is 30 frames/sec. However, the frame rate of image data handled by the camera controlling chip 304′ is more than 30 frames/sec, such that a plurality of image data 482′, 484′ and 486′ can be handled at the same time without influencing the quality of the image to be output.

As mentioned in the embodiments according to the present invention, the transmission interface specification of the peripheral transmission interfaces 308, 308′ and the peripheral interface ports 320, 320′, may be a serial transmission interface specification, such as USB, PCI Express, Serial ATA, or a parallel interface specification, such as PCI, IDE, Parallel ATA. The host devices 330, 330′, may be widely applied to various devices, such as desktop computers, notebook computers, cellular phones, personal digital assistants, web video telephone devices and video conference systems, etc. The image sensors 302, 402′, 404′ and 406′, fall within various categories of image sensors, such as CMOS (Complementary Metal-Oxide-Semiconductor) image sensors and CCD (Charge-Coupled Device) image sensors.

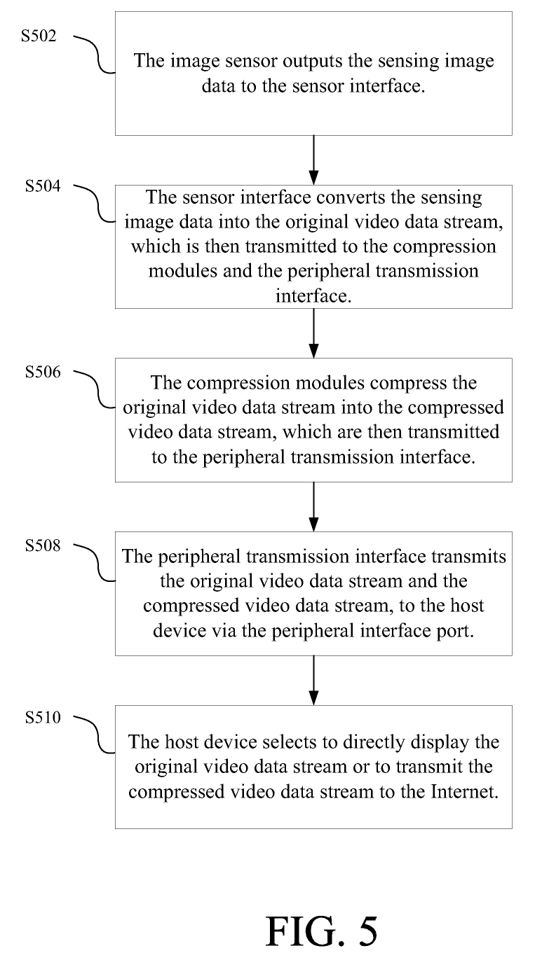

FIG. 5 illustrates a flow chart of the multi-streaming web camera controlling system and a controlling methodology of the same according to the present invention. An exemplary embodiment, the multi-streaming web camera controlling system according to the FIG. 3, includes the following steps:
S502: The web camera controlling chip 304 utilizes the sensor interface 306 to receive the sensing image data 382 (or a plurality of sensing image data 482′, 484′ and 486′ as shown in FIG. 4) output from the image sensor 302 (or a plurality of image sensors 402′, 404′ and 406′ as shown in FIG. 4).
S504: The sensor interface 306 converts the received sensing image data 382 (or a plurality of sensing image data 482′, 484′ and 486′ as shown in FIG. 4) into the original video data stream 384, which is then transmitted to the peripheral transmission interface 308 and the compression modules 310a, 310b and 310c at the same time.
S506: The compression modules 310a, 310b and 310c compress the original video data stream 384 into the corresponding compressed video data stream 386a, 386b and 386c, which are then transmitted to the peripheral transmission interface 308.
S508: The peripheral transmission interface 308 transmits the collected original video data stream 384 and the compressed video data stream 386a, 386b and 386c to the host device 330, via the peripheral interface port 320. The control unit 312 controls the corresponding circuit blocks to stop generating the image data format unused by the host device 330 based on the instruction of the host device 330 or by detecting the function thereof.
S510: The host device 330 selects to directly display the original video data stream 384 or to transmit the compressed video data stream 386a, 386b or 386c via the Internet 350.

As described above, the multi-streaming web camera controlling system and the controlling methodology of the same according to the present invention, based on the image data format(s) required by host device, generate an original video data stream and one or many corresponding compressed video data streams at the same time. Therefore, the occupancy of system resource of host device for image processing, or the influence of the Internet bandwidth for transmitting original video data stream, is dramatically reduced. As a result, the quality of image to be output is improved, and some disadvantages in prior arts, such as delay, freeze or inconstant display of camera frame, can be resolved. Meanwhile, the setup cost of host device is lowered and the speed of image data processing is accelerated.

On the other hand, the multi-streaming web camera controlling system according to the present invention, may directly and simultaneously compress abundant of image data, via a plurality of compression modules other than any circuit or device, thereby generating the instant original video data stream and corresponding compressed video data stream to meet with the demand for image by the local and the remote.

The above description is only a better embodiment according to the present invention. Any equivalent modification or change, based on the spirit of the present invention, by any professional who knows well the technology according to the present invention, is covered within the scope of the attached patent application.

What is claimed is:

1. A multi-streaming web camera controlling system comprising:
a sensor interface, for receiving at least a sensing image data and for converting the sensing image data into an original video data stream;
one or more compression modules, for determining whether to compress the original video data stream into a compressed video data stream in a corresponding image compression format based on a control signal;
a peripheral transmission interface, for delivering the original video data stream and the compressed video data stream upon collecting the original video data stream and the compressed video data stream; and
a control unit, for determining an operation of the one or more compression modules or the sensor interface based on a command.

2. The multi-streaming web camera controlling system of claim 1 further comprising an image sensor for generating the sensing image data.

3. The multi-streaming web camera controlling system of claim 1, further comprising:
a peripheral interface port for receiving the original video data stream and the compressed video data stream and outputting the original video data stream and the compressed video data stream; and
a host device for receiving the original video data stream and the compressed video data stream, and for selectively displaying the original video data stream or transmitting the compressed video data stream via the Internet.

4. The multi-streaming web camera controlling system of claim 1, further comprising a plurality of image sensors, each image sensor for outputting the sensing image data to the sensor interface.

5. The multi-streaming web camera controlling system of claim 1, further comprising a plurality of compression modules, each compression module for compressing the original video data stream into a compressed video data stream in a corresponding image compression format, respectively.

6. The multi-streaming web camera controlling system of claim 1 or 5, wherein the compression format is selected from a group consisting of MPEG1, MPEG2, MPEG4, H.263, H.264/AVC, Real Video, VC-1, and AVS.

7. The multi-streaming web camera controlling system of claim 3, wherein the peripheral transmission interface and the peripheral interface port comply with USB, PCI Express, and Serial ATA serial transmission interface specifications, or PCI, IDE, and Parallel ATA parallel interface specifications.

8. The multi-streaming web camera controlling system of claim 3, wherein the host device embodies in a desktop computer, a notebook computer, a cellular phone, a personal Digital Assistant (PDA), a web video telephone device, and a video conference system.

9. The multi-streaming web camera controlling system of claim 2 or 4, wherein the image sensor comprises a Complementary Metal-Oxide-Semiconductor (CMOS) image sensor or a Charge-Coupled Device (CCD) image sensor.

10. A method of controlling a multi-streaming web camera, comprising:
utilizing a sensor interface to receive sensing image data outputted from one or more image sensors, and converting the received sensing image data into original video data stream, which is then transmitted to a peripheral transmission interface and a compression module simultaneously;
compressing the original video data stream with the compression module into a corresponding compressed video data stream, which is then transmitted to the peripheral transmission interface;
utilizing the peripheral transmission interface to transmit the original video data stream and the compressed video data stream to a host device, via the peripheral interface port; and
selectively displaying the original video data stream or transmitting the compressed video data stream via the Internet.

11. The method of claim 10, wherein the sensor interface receives a plurality of sensing image data outputted from the one or more image sensor simultaneously, and converts the plurality of sensing image data into the original video data stream.

12. The method of claim 10, wherein the sensor interface outputs the original video data stream to a plurality of compression modules simultaneously, and each compression module is used for compressing the original video data stream into a compressed video data stream in a corresponding image compression format, and for outputting the compressed video data stream to the peripheral transmission interface.

13. The method of claim 10, wherein the compression format is selected from a group consisting of MPEG1, MPEG2, MPEG4, H.263, H.264/AVC, Real Video, VC-1, AVS.

14. The method of claim 10, wherein the peripheral transmission interface and the peripheral interface port comply with USB, PCI Express, Serial ATA serial transmission interface specification, or PCI, IDE, Parallel ATA parallel interface specification.

15. The method of claim 10, wherein the host device comprises a desktop computer, a notebook computer, a cellular phone, a Personal Digital Assistant (PDA), a web video telephone device and a video conference system.

16. The method of claim 10, wherein the image sensor comprises a Complementary Metal-Oxide-Semiconductor (CMOS) image sensor or a Charge-Coupled Device (CCD) image sensor.
